(19) United States
(12) Patent Application Publication
(10) Pub. No.: US 2008/0265465 A1
(43) Pub. Date: Oct. 30, 2008

(54) Apparatus for Injection Compression Molding and Method of Molding Articles

(75) Inventor: Pierre GLAESENER, Bissen (LU)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: HUSKY INJECTION MOLDING SYSTEMS LTD., Bolton (CA)

(21) Appl. No.: 11/739,128

(22) Filed: Apr. 24, 2007

(51) Int. Cl. B29C 45/00

(52) U.S. Cl. 264/328.1; 425/149

(57) ABSTRACT

In a stack mold or Tandem® molding machine (10) of FIG. 1 that employs injection compression techniques, a separation (δ₁ and δ₂) between hot halves (24, 26) and cold halves (28, 30) of first and second molds (15, 16) is controlled by sensed distance measurements between a centre-section carrier (17) and end platens (18, 20) on which the molds (15, 16) are mounted. First and second stroke cylinders (66, 68), under the control of machine controller (14) and subject to the sensed positions of the platens (18, 20), balance an injection compression stroke (F_{CLP}) generated by a clamp assembly (48). Specifically, the stroke cylinders (66, 68) control a relative rate of closure between the two molds (15, 16) to provide, as appropriate, synchronous closure of the hot halves (24, 26) against the cold halves (28, 30).

### FIELD OF THE INVENTION

This invention relates, in general, to an apparatus and process that make use of an injection compression technique and more particularly, but not exclusively, to the control of the compression stroke in the molding of plastic parts in a multi-mold environment.

### SUMMARY OF THE PRIOR ART

Injection compression molding is a process in which a mold is progressively closed either after injection of a complete shot of melt (or putty) into a mold cavity or simultaneously with the injection of the melt into the cavity. Specifically, initial movement of a moving platen relative to a stationary platen causes the respectively supported mold halves to be brought into relatively close proximity, whereafter the tie-bars are positively engaged by a clamp unit. At this point, a small axial movement of the clamp piston is still possible: i) to develop clamp force through the taking-up/elimination of this residue space; ii) to effect final closure of the mold; and thereby iii) to define a final cavity volume of the mold. In this regard, accurate hydraulic pressure control is typically used to displace axially the clamp piston, thereby finally closing the force path through the mold and the machine and to develop full tonnage. Through this process, the melt is generally slowly squeezed to fill out the volume of the cavity.

A typical clamp mechanism (and related piston assembly) is described in European patent EP-B-0904918.

In conventional injection molding processes, a pressure profile in the cavity varies from a maximum pressure adjacent the gate (i.e. the injection point) to a minimum pressure at an end of the cavity farthest from the gate. In fact, the pressure at the gate can be substantial, while the average pressure seen through the cavity is essentially that experienced at the mid-point between the gate and the remote end of the cavity. Indeed, as will be understood, the size of the machine (in terms of both the components and the ability to develop clamp tonnage) is determined by the force required to counteract the injection pressures seen within the mold, with the clamp force set so as marginally to exceed the desire of the mold to break open during (particularly) the injection phase. In contrast, compression molding considerably reduces the average injection pressure and also the maximum shear rate in the mold cavity since the partly opened mold presents a higher cavity wall spacing for the plastic to be injected. In this way, relative to conventional injection molding techniques, compression molding can mold identical parts in smaller (lower clamp tonnage) machines or otherwise to mold larger parts in machines of comparable clamp tonnage.

Consequently, compression molding has a positive price influence on production because the cost per part relative to capital outlay (i.e. the “return on capital employed”) is considered better than conventional injection molding. Furthermore, with lower pressures, shear stresses within a molded part are decreased, with this resulting in generally higher part quality. The significant drawback with compression molding, however, is that its applicability is somewhat limited to simple parts having a generally flat, two-dimensional geometry (in the sense that the geometry is generally transverse to the applied force), since compression effects are limited in features having a depth parallel to the applied force. In this respect, compression molding has particular advantages with large area panels or sheets, e.g. polycarbonate sheets used as windows in cars and the like.

Following filling of the cavity, the melt begins to cool and shrink away from the surfaces of the mold cavity, the shrinkage is compensated by compression of the part; this compression stroke also reduces surface defects associated with shrinkage.

For a nominal (final) part thickness of a few millimetres, the compression stroke will be a fraction (and probably about 10%) of the total thickness of the final part.

In a conventional single mold environment where a single (but potentially multi-cavity) mold is secured between a stationary and moving platen, control of the compression stroke is facilitated by control of the clamp cylinders. Given the available surface area over which the hydraulic fluid is capable of working, a high degree of control is achieved through regulation of the fluid volume and related pressure.

Compression molding can also be used in combination with other molding technologies, including in-line compounding.

To increase productivity, injection molding technology has also developed stack molds in which multiple molds are located/distributed between three or more platens. For example, a centre-section carrier may support a hot side on both of its opposing mold mounting surfaces, whereas a fixed (or end platen) and a moving platen may each support the mounting of a corresponding cold side. In the event that the centre section carrier is rotatable, separate injection units interface into each of the stationary platen and moving platen. Rotation of the centre-section carrier therefore makes it possible for such a system to produce overmold parts.

A conventional stack mold system is described in European patent EP-B-0963828 in which a combination of a stroke cylinder and a linkage arm (connected between the various platens) permits the stroking of the platens to open and close the molds by the same amount on either side of the centre section carrier. One such commercial available stack mold is the earlier Tandem® molding machine (with linkage arms) supplied by the Applicant.

However, a problem arises when one wishes to implement an injection compression process in a stack mold environment. While the residue movement of the clamp piston will be greater than the summed total of the initial separation between the hot and cold sides of each mold in the stack mold system, the adjustment (i.e. the compression stroke) is insensitive to where and to what extent the mold separation is different between the first and second molds on either side of the centre-section carrier. More particularly, while the clamp piston can provide the compression stroke, the molding process may generate non-symmetrical closure forces acting on the two molds; this results in mold damage in instances where the forces becomes too high. For example, non-synchronized mold closure may result from: i) differing friction effects; ii) different mold geometries; iii) different melt properties (such as differing viscosities of the injected molten resins; iv) different resins types; v) different resin temperatures); and/or vi) different operating temperatures of the molds. This problem simply doesn't arise with a single mold environment.

US patent application 2006/0108702 to Rossanese et al describes an apparatus and method for injecto-compression molding of articles made from plastic material. More specifically, this patent application describes a stack mold in which an overmolding process is completed following necessary rotation of a central turret element (i.e. a centre section carrier). Moreover, to be able to carry out injecto-compression with the necessary precision, position transducers and/or pressure transducers provide parameter measures to an electronic control system for the press. The hydraulic closing assembly and horizontal guide columns, under the control of an algorithm that makes use of the measured parameters, influence the rate of closure of the two molds to ensure that the respective mold halves remain parallel to one another. By ensuring parallelism between mold surfaces, the two-stage overmolding process should not further exaggerate any distortion in the geometry of the plastic part arising from any sub-optimal molding in the first stage. Indeed, the objective of US patent application 2006/0108702 is to ensure that the step of “compression is carried out in a parallel way to distribute the material within the cavity in the best possible way so as to prevent adverse effects on the internal stresses of the moulded piece (“in mould stresses”) and hence on its deformations and mechanical and optical characteristics, in the case of transparent items”, i.e. to guarantee correct execution of the compression molding process.

### SUMMARY OF THE INVENTION

According to a first aspect of the present invention there is provided an injection molding system supporting an injection compression phase, the molding system comprising: a clamp unit for generating, in use, clamp tonnage, the clamp unit containing: a first platen; a second platen; a carrier between the first platen and the second platen; stroking means located between the platens to open and close the first and second platens relative to the carrier; and distance measurement sensors associated with each of the first and second platens to determine a first separation arising between the first platen and the carrier and a second separation arising between the second platen and the carrier; a controller responsive to the first separation and the second separation the controller coupled to the stroking means so as to control independently the first separation and the second separation during the application of clamp tonnage during the injection compression phase.

According to another aspect of the present invention there is provided a method of compression molding articles in a molding system containing a clamp unit for generating clamp tonnage, the clamp unit having a first platen, a second platen, a carrier between the first platen and the second platen and stroking means located between the platens to open and close the first and second platens relative to the carrier, the method comprising: determining a first separation between the first platen and the carrier and a second separation between the second platen and the carrier; responsive to the first separation and the second separation, controlling the stroking means to control independently the first separation and the second separation during the injection compression phase.

In a further aspect of the present invention there is provided a machine controller arranged to regulate first and second separations periodically arising between three mold carrier plates, the machine controller arranged to control independently the first separation and the second separation during an injection compression phase of a machine cycle.

Advantageously, the present invention is able to augment existing injection compression technology by providing a stack mold system that supports greater productivity while maintaining part quality. The system of the preferred embodiment also allows for non-equal cylinder compression strokes whihc may be desirable when simultaneously molding different parts. Additionally, the control offered by the preferred embodiment permits an ability to run in a single patent/mold independently of the second mold (on the other side of the centre-section carrier).

### BRIEF DESCRIPTION OF THE DRAWINGS

Exemplary embodiments of the present invention will now be described with reference to the accompanying drawings in which:

FIG. 1 is a schematic representation of a clamp unit and related control assembly of a preferred embodiment of the present invention; and

FIG. 2 is a flow diagram detailing the preferred process steps in a method of controlling a relative rate of closure between two molds in a stack molding injection molding system of FIG. 1.

### DETAILED DESCRIPTION OF A PREFERRED EMBODIMENTS

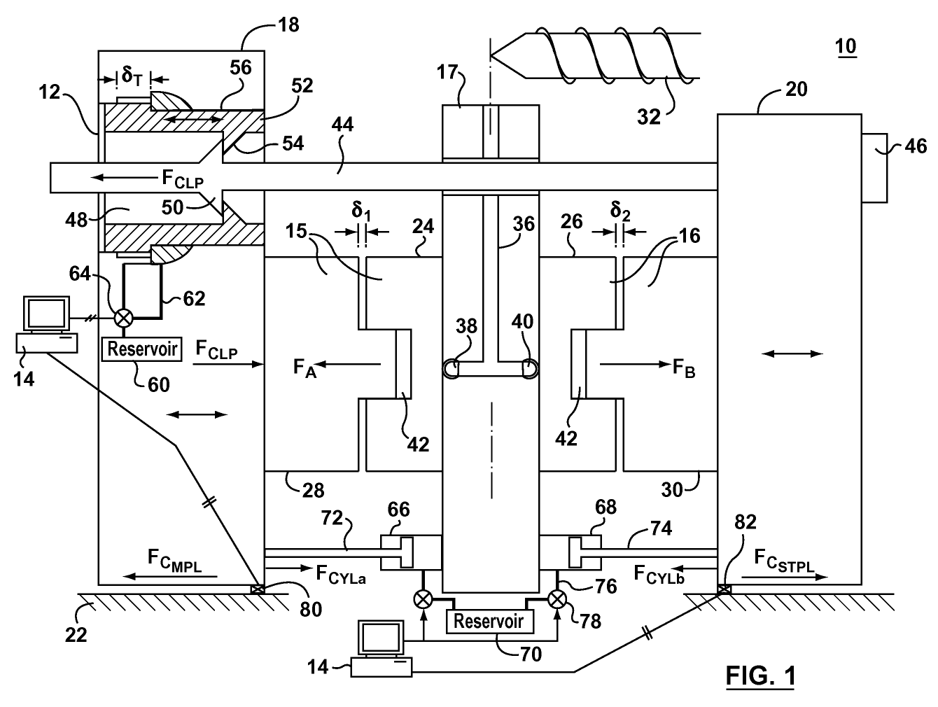

Referring to FIG. 1, according to a preferred embodiment of the present invention, there is shown an injection molding system 10 incorporating a clamp unit 12 and related control system 14. The injection molding system 10 is shown as a Tamdem® molding system containing a first mold 15 and a second mold 16 each sandwiched between a centre section carrier 17 and either one of a first moving platen 18 or a second platen 20. In a preferred embodiment, the centre section carrier 17 is fixed (i.e. stationary), with this meaning that the second platen 20 must also be movable. As necessary, the first and second platens 18, 20 slide along a machine base 22, with sliding accomplished by any suitable means, e.g. the use of shoes or linear bearings. The benefit of having the centre section carrier 17 fixed in place is that both moving platens 18, 20 will essentially see the same friction forces during their respective movements relative to the centre section carrier 16. The system 10 is configured to support an injection compression technique into preferably both of the first 15 and second 16 molds on a simultaneous injection compression basis.

As will be understood, each mold 15, 16 comprises a hot half 24, 26 and a cold half 28, 30. Conventionally, each hot half will be secured to mold mounting faces of the centre section carrier 17, thereby permitting a plasticizing unit 32 to interface centrally (through a sprue, not shown) to a manifold distributor 36, such as a hot runner system. The manifold distributor 36 provides distinct flow paths to separate nozzles 38, 40 that each feed, in use, plastic resin into each hot half 24, 26. Each cold half 28, 30 is mounted to a mold mounting face of either the first or second moving platens 18, 20 and necessarily aligned with its associated hot half. A cavity 42 (which need not be identical in geometry between the molds 15, 16) is formed by bring together the hot half and cold half of each mold.

Detailed explanation of the general molding process and equipment is not considered necessary since the underlying technology is well know in the art. For example, as previously indicated, the molds may actually include pre-heat elements (not shown) to facilitate the effective compression molding of polycarbonate articles.

In terms of the clamp unit 12, tie-bars 44 (or the like) selectively permit the selective securing together of the platens and therefore the closing of the force path. For the sake of clarity, the system is shown with only a representative tie-bar 44 fixedly attached to one of the end platens, namely the second moving platen 20 (in this exemplary embodiment), with a tie-bar nut 46. Of course, rather than using tie-bars, one could also use a toggle mechanism, but this is merely a design option and does not significantly affect the underlying principal of the invention. The tie-bar 44 passes through the centre-section carrier 17 and then is selectively secured to the first moving platen 18 with a clamp mechanism 48. In a particular preferred embodiment, the tie-bar 44 includes a “pineapple” head realized by circumferential rows of external teeth (schematically represented as locking feature 50), although the locking feature 50 on the tie-bar can be a half-nut or any functional equivalent. To engage the locking feature 50, the clamp mechanism 48 of the preferred embodiment makes use of a rotating piston 52 through which the tie-bar may selectively pass (subject only to whether the locking feature 50 of the tie-bar 44 is positively engaged by teeth 54 or the like on the rotating piston 52). A more detailed technical description of the structure and operation of the piston in its engagement of the tie-bar 44 and the development of clamp tonnage is not considered necessary since the principles are well known and described, for example, in the aforementioned European Patent EP-B-0904918. It is suffice to say that the clamp piston 52 is located within a bore 56 that cooperates to define cavities into which hydraulic fluid can be supplied or drained: i) to develop clamp tonnage; ii) to move the piston laterally to take-up residue space within the clamp mechanism 48 to produce applied clamp tonnage; and iii) to generate mold break forces. In this respect, the supply or draining of hydraulic fluid from and to a reservoir 60 is regulated under the control of the machine's control system 14 and a suitable network of conduits 62 and valves 64. Small lateral displacement of the piston 52 (in its engaged positioned) relative to the tie-bar 44 are represented by the distance δ_{T}.

Again, the exact form of implementation and control of the clamp mechanism 48 is down to design freedom and is therefore shown in the context of a hydraulic circuit for reasons of explanation only.

The injection molding system 10 also includes first and second stroke cylinders 66, 68 secured between the centre-section carrier 17 and respectively the first and second platens 18, 20. The stroke cylinders 66, 68 fundamentally operate in a conventional way to stroke the moving platens to open and close the molds 15, 16. Consequently, the stroke cylinders 66, 68 are conventionally connected to a supply/reservoir 70 of hydraulic fluid (or the like) and the stroking of their respective pistons 72, 74 controlled by the machine's control system 14 and a related network of conduits 76 and valves 78. The stroke cylinders 66, 68 could, alternatively, be implemented by some form of electrical drive, e.g. a worm drive. The stoke cylinders 66, 68 will typically also include pressure sensors and the like, although these are not shown (for reasons of clarity of the drawing).

The injection molding system 10 also includes a position measurement system realized by sensors 80, 82 (such as Temposonic™ sensors) that generate measurement parameters for use by the control system 14. Specifically, the sensors 80, 82 provide position measurement information of the moving platens 18, 20 relative to a fixed point, e.g. the stationary centre-section carrier 17 (in a preferred embodiment) via the clamp base. The sensors may be positioned at any appropriate point that provides a viable measurement.

The control system 14 is therefore able to sense the relative separation (δ₁ and δ₂) between the hot side and cold side of each mold 15, 16 from the point in time when compression molding is about to commence. For completeness it is noted that, at commencement of compression molding, the sum of the relative separations δ₁ and δ₂ will be less than the avialable take-up δ_{T} permitted within the piston 52.

In terms of the various forces acting within the injection molding system 10, clamp tonnage (F_{CLP}) is developed by clamp mechanism 48, which force is seen in a force ring comprising all the tie-bars 44 and at the mold mounting surface of the first moving platen 18 and in a direction towards the centre-section carrier 17. In relation to the first mold 15, a reaction force F_{A} opposes this clamp tonnage F_{CLP}. Similarly, in relation to the second mold 16, a reaction force F_{B} opposes this clamp tonnage F_{CLP}. In terms of the stroke cylinders 66, 68, the first and second cylinders each generate directionally opposing stoke cylinder forces (F_{CLYa} or F_{CLYb}) away from their respective connections to their associated moving platens 18, 20. Finally, each moving platen 18, 20 sees a reaction force (F_{CMPL} or F_{CSTPL}) that diametrically opposes the applied clamp force F_{CLP}.

In operation, i.e. at the start of and during compression molding, the control system 14 regulates the pressures applied by the stroke cylinders 66, 68 to balance the injection compression stroke between the two molds, thereby maintaining a substantially equal mold half separation between the hot half 24, 26 and the cold half 28, 30 of the first and second molds 15, 16. The clamp mechanism 48 generates the closing force F_{CLP} and injection compression stroke for all the molds in the stack to support, if desired, simultaneous injection compression molding. In other words, the system controller 14 controls the relative rate of closure between the molds 15, 16 in the system 10. Control of the rate of closure between the two molds can be either disparate or synchronized (e.g. δ₁ is always controlled to be substantially if not exactly δ₂), subject to any varying geometries in the parts being molded in the first and second molds 15, 16. For the sake of explanation only, the preferred embodiment describes the use of two molds, although the stack mold system may contain more.

With mold closure, it is clearly desirable that parallelism between contact surfaces of the hot half and the cold half is maintained and controlled, as appropriate, e.g. via proper guidance of the moving platen.

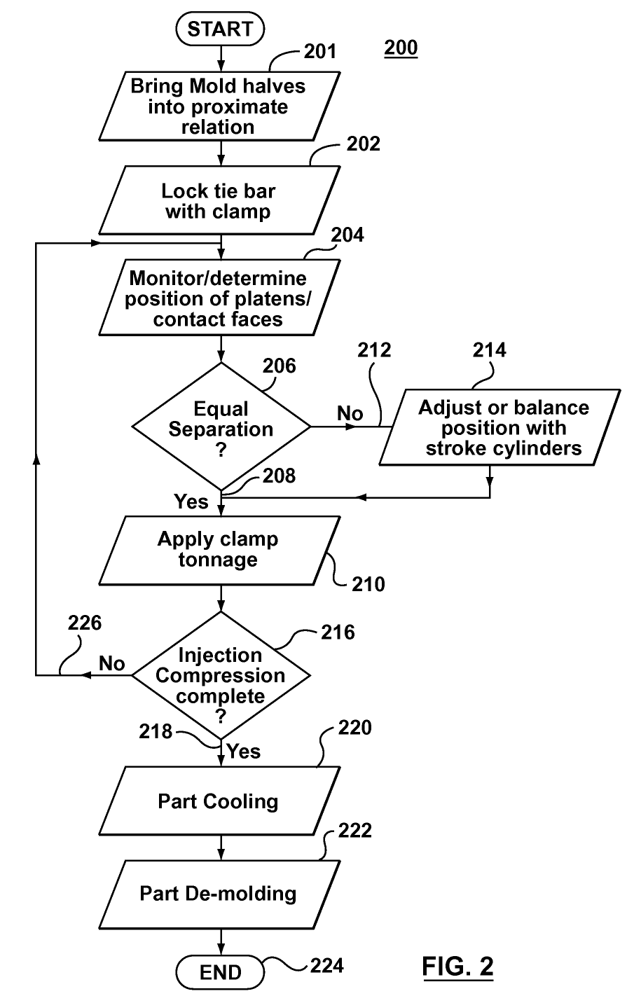

FIG. 2 is a flow diagram of a preferred embodiment of the process 200 of the present invention. The cyclic process begins with the initial stroking 201 of the platens (by the stroke cylinders 66, 68) to bring the mold halves 15, 16 into a proximate relation. At this point, the tie-bar 44 can be locked 202 by rotation of the piston to cause interlocking of complementary rows of interlocking teeth on the piston 52 and tie-bar 44. At this point, the system monitors or otherwise determines 204 the position of the platens and thus the positions of the contact faces along a split line in each mold. Of course, position monitoring may be continuous. A determination 206 is then made as to whether a separation between the contact faces of the hot and cold sides is within specification (e.g. equal). In the affirmative 208, clamp tonnage is (progressively) applied 210 and the piston advanced. In default 212, one or more of the stroke cylinders is actuated 214 to adjust or balance the distance separation between the contact faces in the mold, whereafter clamp tonnage can be (progressively) applied 210. An assessment 216 is then made as to whether the compression cycle is completed and, in the affirmative 218, part cooling 220 and then demolding 222 occurs to permit the cycle to begin again 224 (“end”). If the injection compression cycle is still incomplete 226, further monitoring of the position and adjustment of the clamp tonnage, piston location is undertaken, i.e. the process enters a monitor and adjustment loop essentially comprising steps 204 to 216.

In an alternative compression molding techniques where foaming agents are used to introduce interstitial (air-filled) voids into the structure of the molded article, it will be understood that, following injection, a decompression stroke may be introduced into the process wherein the mold is slightly opened up to promote the foaming effect. A preferred embodiment of the present invention contemplates that the stoke cylinder 66, 68 can, as appropriate, support this mold opening phase.

The present invention may find particular application in glazing applications where large panels of clear plastic (e.g. polycarbonate) are molded for windows for cars and the like.

It will, of course, be appreciated that the above description has been given by way of example only and that modifications in detail may be made within the scope of the present invention. For example, while the preferred embodiment of the present invention has been described in the context of a Tandem® molding (multi-platen) machine, the principal of counter-balancing the injection compression stroke by selectively controlling the degree of energization of the stroke cylinders can be applied, if desired, to augment control in a single mold environment. Equally, the present invention can find application in any molding technology that benefits from injection compression, irrespective of the size of the part to be molded or the material from which the molded part is to be formed. Equally, while the present invention has been described in relation to a stack mold having a fixed centre-section carrier, the reference (stationary) platen could equally be at one end of the injection molding system. Moreover, if desired, the present invention could also find application in a molding system in which overmolding occurs through periodic, indexed rotation of the centre-section carrier, irrespective of whether this centre section carrier 17 is linearly stationary or subject to movement relative to a fixed platen.

Furthermore, the principal of controlling the relative closure of the molds could also be applied in a single mold in instances where the single mold included separate (i.e. laterally displaced) nests of cavities.

1. An injection molding system supporting an injection compression phase, the molding system comprising:
a clamp unit containing:
a first platen, configures to support part of a first mold;
a second platen, configured to support part of a second mold;
a carrier between the first platen and the second platen, configured to support part of each of the first mold and second mold;
stroking meaans, coupled with the first platen and the second paten, and operable to open and close the first and second platens relative to the carrier;
a clamp mechanism, operable to generate clamp tonnage and compress the first and second molds during the injection compression phase; and
position measurement sensors associated with each of the first and second platens to determine a first separation arising between the first platen and the carrier and a second separation arising between the second platen and the carrier;
a controller, coupled with the position measurement sensors, the controller being responsive to the first separation and the second separation, the controller coupled to the stroking means so as to control independently the first separation and the second separation during the application of clamp tonnage during the injection compression phase.

2. The injection molding system according to claim 1, wherein
the first mold has a hot side and a cold side, one of the hot side and the cold side coupled to the first platen and the other one of the cold side and the hot side coupled to the carrier; and
the second mold has a hot side and a cold side, one of the hot side and the cold side coupled to the second platen and the other one of the cold side and the hot side coupled to the carrier; and
wherein the controller is arranged to control the relative rate of closure between the hot sides and the cold sides of each of the first mold and the second mold during the application of tonnage during the injection compression phase.

3. The injection molding system according to claim 2, wherein the clamp mechanism includes a piston arranged, in use, to generate clamp force for an injection compression stroke in the first mold and the second mold.

4. The injection molding system according to claim 3, wherein the controller is arranged to cause the stroking means to balance the injection compression stroke between the first mold and the second mold.

5. The injection molding system according to claim 1, wherein the carrier is stationary and the first and second platens are movable under action of the stroking means.

6. The injection molding system according to claim 5, wherein the carrier is arranged to rotate.

7. A method of compression molding articles in an injection molding system supporting an injection compression phase, containing a clamp unit, the clamp unit having a first platen for supporting part of a first mold, a second platen for supporting part or a second mold, a carrier between the first platen and the second platen, the carrier for supporting part of each of the first mold and the second mold, stroking means located between the first platen and the second platen to open and close the first and second platens relative to the carrier, and a clamp mechanism, operable to generate clamp tonnage and compress the first and second molds during the in jection compression phase:
the method comprising:
determining a first separation between the first platen and the carrier and a second separation between the second platen and the carrier;
responsive to the first separation and the second separation, controlling the stroking means to control independently the first separation and the second separation during the application of clamp tonnage during the injection compression phase.

8. The method of compression molding articles according to claim 7, wherein the step of controlling the stroking means includes balancing an injection compression stroke between the first mold and the second mold coupled respectively between the first platen and the carrier and the second platen and the carrier.

9. A machine controller for an injection molding machine supporting an injection compression phase arranged to regulate a first separation and a second separation periodically arising between three mold carrier plates, the machine controller arranged to control independently the first separation and the second separation during the application of clamp tonnage during the injection phase of a machine cycle.

10. The machine controller according to claim 9, wherein the machine controller is arranged, in use, to balance an injection compression stroke between first and second molds coupled respectively coupled between a first mold carrier plate and a centre section carrier and a second platen and the centre section carrier.
